(19) United States
(12) Patent Application Publication
(10) Pub. No.: US 2002/0113800 A1
(43) Pub. Date: Aug. 22, 2002

(54) Method of creating a full color display

(76) Inventors: Peter W.J. Jones, Belmont, MA (US); Dennis W. Purcell, Medford, MA (US)

Correspondence Address: ROPES & GRAY, ONE INTERNATIONAL PLACE, BOSTON, MA, 02110-2624, US

(21) Appl. No.: 09/919,584

(22) Filed: Jul. 30, 2001

Related U.S. Application Data
(60) Provisional application No. 60/221,580, filed on Jul. 28, 2000.

(51) Int. Cl. G09G 5/02

(52) U.S. Cl. 345/589

(57) ABSTRACT

A technique for using only two different color elements in a display to give a viewer the effect of a full color range output that would otherwise require the use of three different color elements, such as red, green and blue. In a particular embodiment a display is made up of a matrix of alternating red and green light-emitting or red and green passing filtering elements; when seen as a whole, the display can create the impression of a full-color depiction of text, graphics and/or photos. The brightness of each light-emitting or filtering element in the display is varied to bear a selected relationship to the brightness the point it represents in a full-color image would have if that point were to be seen through a long wave pass filter (for the red element) or short wave pass filter (for the green element).

### RELATED APPLICATIONS

This application claims priority to earlier filed U.S. Provisional Application No. 60/221,580 filed Jul. 28, 2000, naming Peter W. J. Jones and Dennis W. Purcell as inventors, the contents of which are hereby incorporated by reference.

### FIELD OF THE INVENTION

This invention relates generally to devices and techniques for creating a display in an electronic device which can give the perception to a viewer of a full range of colors by use of only two different color elements (a longer wavelength and a shorter wavelength), rather than by the use of three (red, green, blue) as is done in current practice.

### BACKGROUND

It is sometimes desirable make an output display for an electronic device, such as cell phone or computer, that is capable of rendering a full range of visible colors. At present, typical methods of doing this have been by means of a matrix of red, green and blue light-emitting or red, green and blue passing filtering points, varying the brightness of these three colors such that the combination of these triplets causes the observer to perceive a full range of colors.

A disadvantage of this method is that it requires use of display elements that are capable of emitting red, green and blue light. Also, it requires three separate control circuits and a bandwidth sufficient to accommodate the three different control signals.

Accordingly, it is highly desirable, if not necessary, to devise other techniques for creating a display capable of giving the perception of a full range of colors by using less than three different color elements.

### SUMMARY OF THE INVENTION

In accordance with the invention, a structure comprising a matrix of two different elements (either light-emitting or light filtering), one element emitting or passing light with a shorter wavelength than the other element.

More particularly, the systems and methods described herein include methods for creating a perception of a fall color display from a matrix of optical elements of a first and second color. The method may include the acts of providing a full color display of optical elements of a first color and a second color and optionally being arranged in an alternating pattern. The method may determine for an image presented on a three color display, the relative brightness for the points of the image produced by the three color display, and translate the relative brightness of these points into a corresponding brightness for the respective points on the two-color display. The method is not limited to operating on relative brightness, and in optional practices, the system may translate relative intensities, power levels or some other characteristic or combination of characteristics.

When translating, the methods may map a three dimensional coordinate that is representative of the relative brightness of the point to a two dimension point. The process may also generate a flashing period, wherein the flashing period is representative of a timing pattern for alternate flashing of a two-color display. For example, the flashing period may be a timing sequence in the range of, for example, 10 to 120 frames per second. Additionally, in further optional embodiments the flashing rate may vary during the display of the image. These color elements may be any suitable set of three different colors, such as red, green, blue. The translation may occur to a two-color display which could be a red green display, a red blue display or some other two-color pair display. It will be apparent to those of skill in the art that the actual colors employed by the full color display and the two-color display may vary depending upon the application, display employed or some other factor. It will further be understood that in some practices the methods described herein may be employed to translate a larger color space, such as a four color space, five color space or some N-color space to some lower dimensional color space.

When translating the systems described herein translate a brightness level, power levels, intensity levels, or some other characteristic, of a plurality of the color elements of the three color display to generate corresponding characteristic values for the color elements of the lower dimensional color display. In one practice the process sums the brightness for the three-color red element with half the brightness of the three-color green element to determine the relative brightness for the two-color red element. Similarly, the practice may sum the brightness for a three-color blue element with half the brightness of the three-color green element to determine a relative brightness for the two-color green element.

In a further optional practice the systems described herein can include generating noise signal representative of a random occurrence of red and green light, and summing the relative brightness of the red component of the noise signal with the relative brightness of the two-color red element and summing the relative brightness of a green component of the noise signal with the relative brightness of a two color green element. Optionally, you can add the noise to only one color component of the display.

In a further optional practice, the two-color display may have a yellow border that surrounds the periphery of the display. The yellow border may appear as a yellow border within the generated image, or as a yellow edge around the periphery of the display. Although not to bound by theory, it is understood that the yellow border provides a more full perception of the color display, including a more full perception of neutral colors appearing within the image.

### BRIEF DESCRIPTION OF THE DRAWINGS

The foregoing and other objects and advantages of the invention will be appreciated more fully from the following further description thereof, with reference to the accompanying drawings, wherein:

FIG. 1 depicts a display according to the prior art that uses three different-color elements to create a full range of colors;

FIG. 2 depicts a small section of a display using three different color elements, showing the matrix of red, green and blue elements;

FIG. 3 depicts a small section of a display using two different color elements, showing the matrix of longer wavelength and shorter-wavelength color elements;

FIG. 4A depicts diagrammatically the brightness levels of the red, green and blue elements at a certain location as they depict a certain color;

FIG. 4B depicts diagrammatically how the brightness levels of a triplet of red, green and blue elements at a certain location in a display using three different color elements can be translated to a set of brightness levels of a doublet of longer-wavelength and shorter-wavelength color elements in a display using two different color elements;

FIG. 5 depicts diagrammatically another manner in which the brightness levels of a triplet of red, green and blue elements at a certain location in a display using three different color elements can be translated to a set of brightness levels of a doublet of longer-wavelength and shorter-wavelength color elements in a display using two different color elements;

FIG. 6 depicts diagrammatically how the output of a triplet of red, green and blue elements can be divided into long wave pass and short wave pass output;

FIG. 7A depicts diagrammatically how individual colors can be defined by use of a three-axis red, green and blue color coordinate system;

FIG. 7B depicts diagrammatically how a two-axis red and green coordinate system can be used to designate a different definition of individual colors that have been defined in a three-axis red, green and blue color coordinate system;

FIG. 8 depicts a small section of a display using two different color elements, showing the matrix of longer wavelength and shorter-wavelength;

FIG. 9 depicts a small section of a display using two different color elements, showing the matrix with only the longer wavelength color elements emitting or passing light;

FIGS. 10A and B depict a small section of a display using two different color elements, showing the matrix with only the shorter-wavelength color elements emitting or passing light;

### DETAILED DESCRIPTION OF CERTAIN ILLUSTRATED EMBODIMENTS

The systems and methods described herein include, among other things, methods for displaying information to a user wherein the information presents the displayed information as a full color image with a full range of color. Systems and methods described further encompass devices, such as hand held computer system, personal digital assistance, cell phones, pagers, video displays, video display drivers, and other types of devices that presents a visual display of information to a user. For the purpose of illustration, the systems and methods of the invention will be described with reference to certain illustrated embodiments. These illustrated embodiments will include systems that manipulate an image with a full range of color, from red to blue, typically an image that may be defined by a three coordinate color system and displayed on a three color element display, commonly a red, green and blue display, and maps the information contained within the three color elements to an image that may be defined by a two coordinate color system and displayed on a two color element display, that may be a red-green color space. Additionally, the systems and methods described herein may introduce a noise signal into the image signal that is being presented on a two-color display. Accordingly, the below description of certain illustrated embodiments will enable those of ordinary skill in the art to understand the invention and to apply the invention in various forms and in various application all of which shall be understood to fall within the scope hereof.

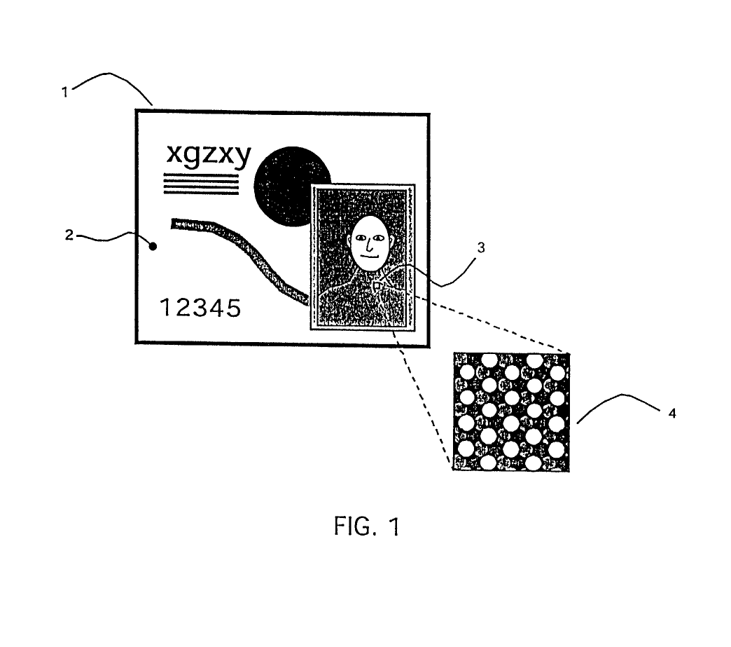

FIG. 1, shows a display, 1 constructed according to the prior art, that can present a representation of graphics, type and/or images, 2 by means of a matrix, 3 shown in detail 4, that is made up of different-color elements. These types of displays are known in the art and are commercially available. The are commonly employed in cell phones, personal digital assistance, hand held computers, and other similar devices. The display 1 may be a liquid crystal display, a light emitting diode (LED) display, a cathode ray tube (CRT) or any of the other types of displays commonly employed for presenting a color image to a user.

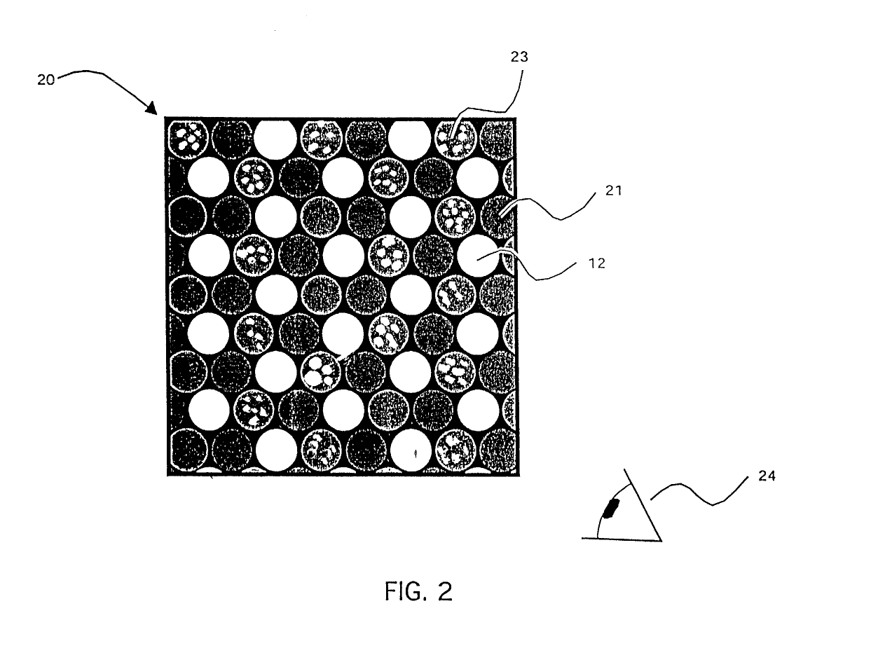

FIG. 2, depicts an enlarged section, 20 of the display matrix showing how it uses three different-colored elements, generally red, 21 green, 22 and blue, 23 to create the perception in a viewer, 24 of a full range of colors. As is known in the art, full color displays with the type depicted in FIGS. 1 and 2 employ the three separate color elements to create a full range of colors. The operation of such displays is well known in the art. Moreover, such displays may be formed from a matrix of optical elements of three different colors, such colors commonly being red, green and blue. However, other displays that employ a matrix of optical elements of colors other than red, green and blue are also known and such systems are capable of presenting full color displays to a user.

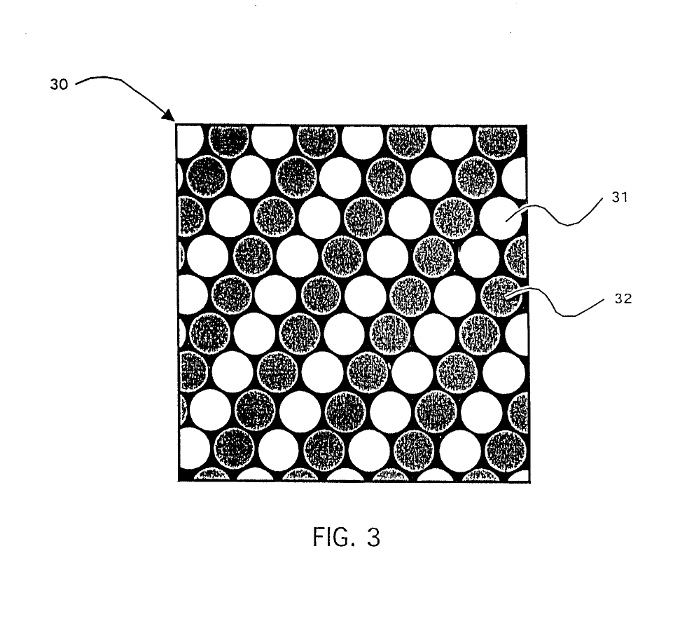

FIG. 3, shows one particular embodiment of a structure in accordance with the systems described herein for a method of using two different-color elements in a display to give a viewer the perception of an output with a full range of colors that would otherwise require the use of three different-color elements. As seen therein, the display's matrix, 30 is made up of two different-colored elements-one type, 32 that emits or passes a longer wavelength band of light and another type, 33 that emits or passes a shorter-wavelength band of light.

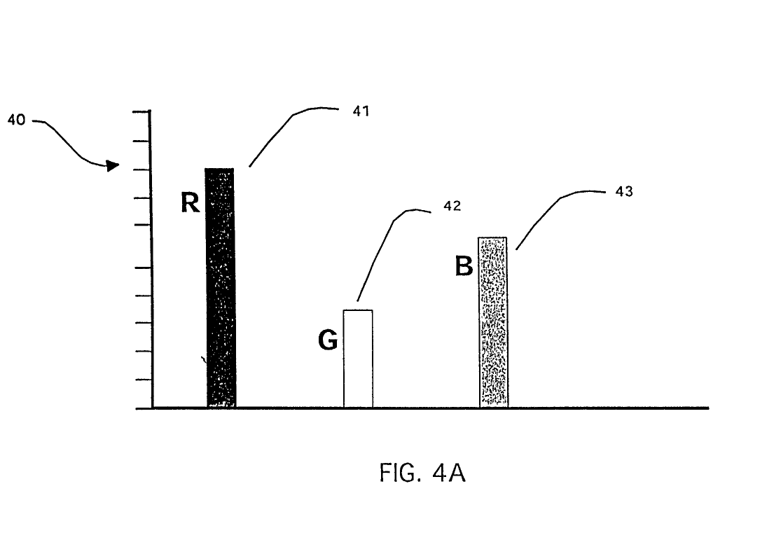

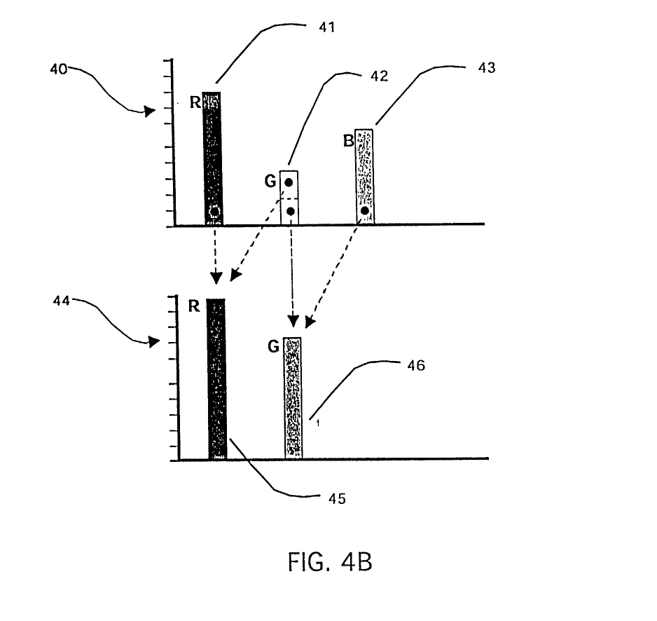

FIG. 4A, depicts diagrammatically by means of a graph, 40 how, at a particular spot in a three-different color element display, the perception of a particular color is produced by the combination of the relative brightness levels of a triplet of the 41, red 42, green and 43, blue light-emitting or red, green and blue passing filtering elements at that particular spot. We have found that one can achieve the perception of a similar particular color (over a wide range, from red to blue) by the use of only two-different-colored elements if, in accordance with the invention, the relative brightness levels of the doublet of two different-colored elements bears a selected relationship to the relative brightness levels of the triplet of three different-colored (generally red green and blue) elements in the traditional display. The two-color element display need simply have one element that emits or passes longer-wavelength light and one that emits or passes shorter-wavelength light, such as red and green.

FIG. 4B, depicts diagrammatically one particular embodiment in accordance with the invention for creating the perception of a full range of colors in a display made with a matrix of two-different color elements. Graph, 40 depicts the relative brightness levels of a triplet of red, 41 green, 42 and blue, 43 light-emitting elements at a spot in a three-color display, where the perception of a particular color is given to a viewer by relative brightness levels of the red, 41 green, 42 and blue, 43 light-emitting elements at that spot. Graph, 44 depicts how this triplet of relative brightnesses is translated into the doublet of relative brightness for a certain spot in a two-color red, green display matrix, where the brightness of the red emitter, 45 is selected as the sum of the brightness values of the three-color red, 41 and half of the brightness value of the three-color green 42 and where the brightness of the green emitter, 46 is selected as the sum of the brightness values of the three-color blue, 43 and half of the brightness value of the three-color green 42. Because of the way the eye/brain combination perceives colors, if this translation is performed over the two-color display matrix, the output will give the viewer the perception of a full range of colors similar to the perception of the full range of colors given by the three-color display matrix. The range of colors will exceed the range of colors normally associated with standard addition or subtraction combinations of the two colors of the display.

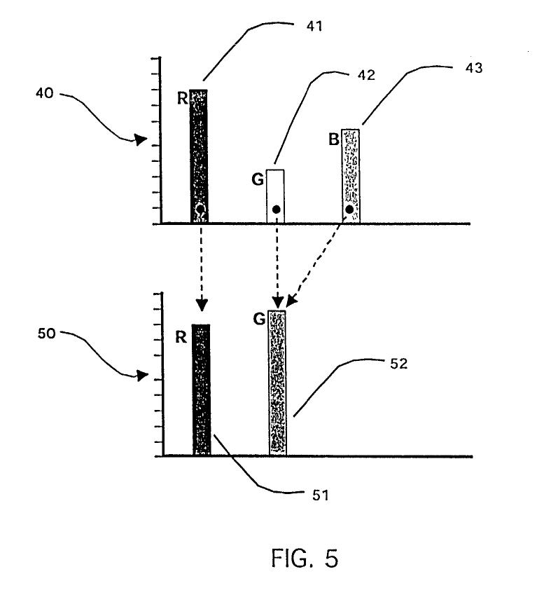

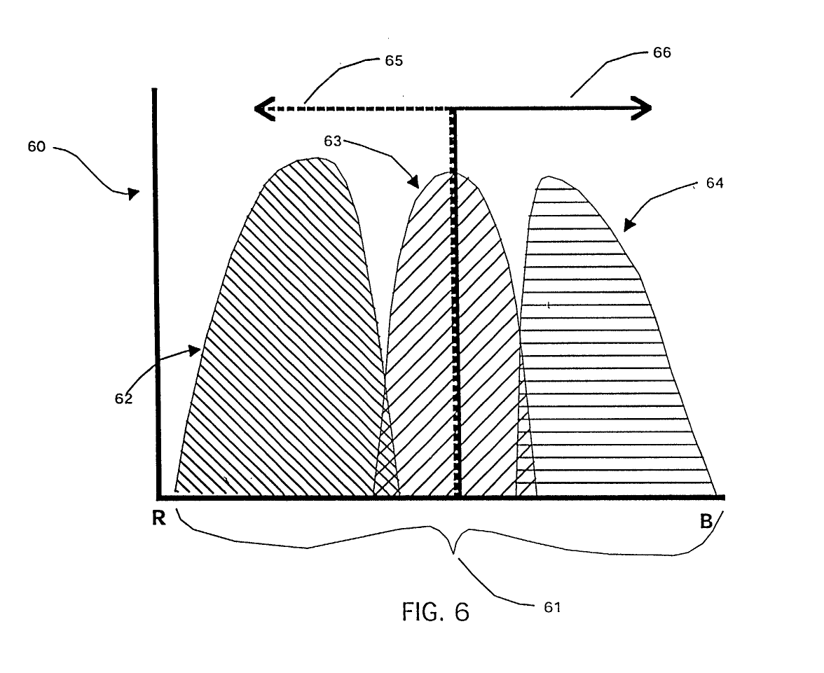

FIG. 5, depicts diagrammatically another particular embodiment in accordance with the invention for creating the perception of a full range of colors in a display made with a matrix of two-different color elements. Graph, 40 depicts the relative brightness levels of a triplet of red, 41 green, 42 and blue, 43 light-emitting elements at a spot in a three-color display, where the perception of a particular color is given to a viewer by relative brightness levels of the red, 41 green, 42 and blue, 43 light-emitting elements at that spot. Graph, 50 depicts another way of translating this triplet of relative brightnesses into the doublet of relative brightness for a certain spot in a two-color red, green display matrix, where the brightness of the red emitter, 51 is selected as the brightness value of the three-color red, 41 and where the brightness of the green emitter, 52 is selected as the sum of the brightness values of the three-color blue, 43 and the brightness value of the three-color green 42.

If the two-color matrix display need only represent a limited universe of colors, such as the limited number of web-safe colors typically used in internet web pages, then rather than an active translation system, the relative brightnesses for the longer and shorter wavelength emitters or pass-filters could be determined by a simple look-up table of values determined to give the desired effect of perception of colors.

When seeking to determine the relative brightnesses doublet for the red and green emitters at a certain spot in a two-color matrix depicting a non-graphical output, such as a video ′″photographic″ image, it is helpful to think of the translation as the same as recording the brightness of the photographed scene through two different filters. FIG. 6, depicts diagrammatically this approach in another particular embodiment of a device in accordance with the invention by means of a graph, 60. According to the prior art, a certain spot in a scene with colors across the visible range, 61 from red to blue is recorded by three receptors, sensitive to red, 62 green, 63 and blue, 64. These receptors give brightness levels for each of the three colors in the triplet which are then used to determine the brightness levels of the red, green and blue emitters at a corresponding spot in a three-color coordinate display matrix. If the same scene were to be recorded through a low-pass filter, 65 and then a high-pass filter, 66, the relative brightnesses of the doublet for the same spot could then be used to determine the brightness levels of the red and green emitters in a corresponding spot in a two-color display matrix in accordance with the invention. The output of the display will then give a viewer the perception of a full range of colors similar to that produced by the three-color display.

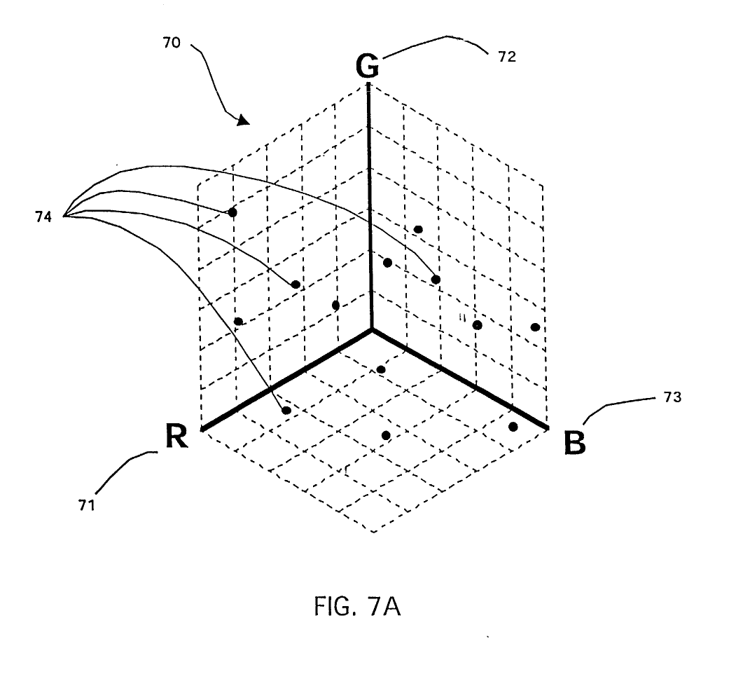

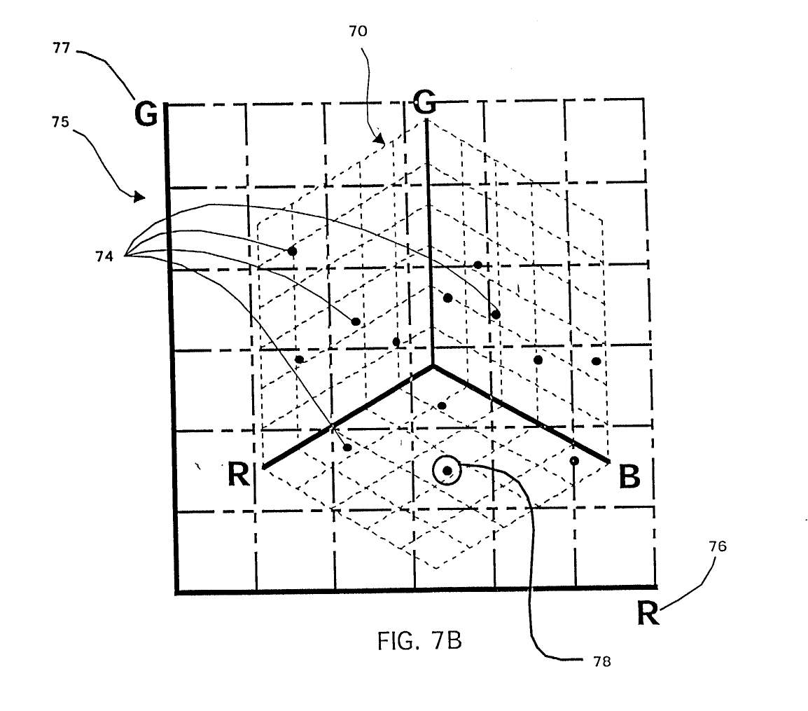

The perceived absolute number of different colors produced by a two-color matrix display will be smaller than that produced by a three-color matrix display, though the range from red to blue will similar. To show why this is so, FIG. 7A, depicts diagrammatically by means of chart, 70 how a red, 71 green, 72 and blue, 73 three-coordinate system can define a large number of different colors, such as those represented by points, 74 in a three-dimensional space. FIG. 7B, depicts diagrammatically another particular embodiment in accordance with the invention how a two-coordinate system, 75 of red, 76 and green, 77 axes can be overlaid on a three-coordinate system, 70 to successfully define many the colors locations, such as those represented by points, 74. It should also be clear that two different colors that could be represented in a three-axis coordinate system, 70 as lying one behind the other at point, 78, could not be successfully defined as separate in the overlaying two-coordinate system, 75. In this way, a smaller number of separate colors can be successfully portrayed by a two-color display matrix, but, because of the way the viewer's eye-brain combination can interpret the relative brightness levels of a longer and shorter wavelength output, this smaller number of separate colors can be perceived across the whole visible color range. If the orientation of the three-axis cube is shifted slightly in relation to the orientation of the two-axis coordinate system then some color point that where hidden in the first orientation of the cube will now become visible (and some that were visible will be come hidden). One strategy to get a richer number of colors represented in the two-axis coordinate system is to in effect keep making small shifts in the orientation of the three-axis cube's orientation and thus produce slight variations in the three-axis color points identifying values in the two-axis coordinate set. This constant slight variation can be interpreted by the eye/brain combination to give a richer set of perceived colors.

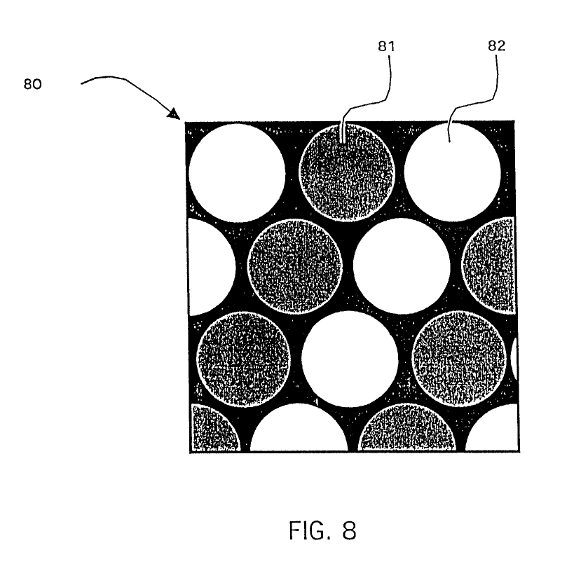

With certain spacings of the elements that make up a display, the eye/brain retinex calculations may not take place, and instead the viewer will see separate red and green spots or a yellow-green, yellow-red effect. FIG. 8, shows another particular embodiment of a structure, 80 in accordance with the invention for a light emitting or filtering matrix, 81 comprised of elements that emit or pass longer, 82 and shorter, 83 wavelengths of light. A lenticular plate, 84 is positioned over the matrix such that at a certain viewing distance, 85 the output of the longer, 86 and shorter, 87 elements of a doublet are superimposed for a viewer, 88.

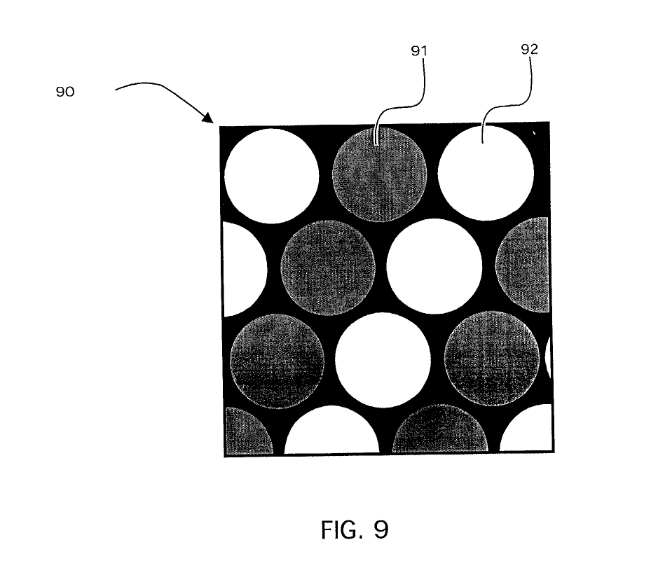

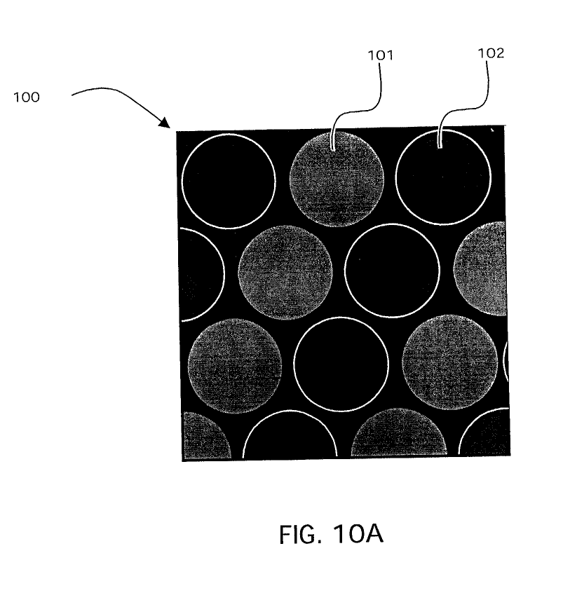

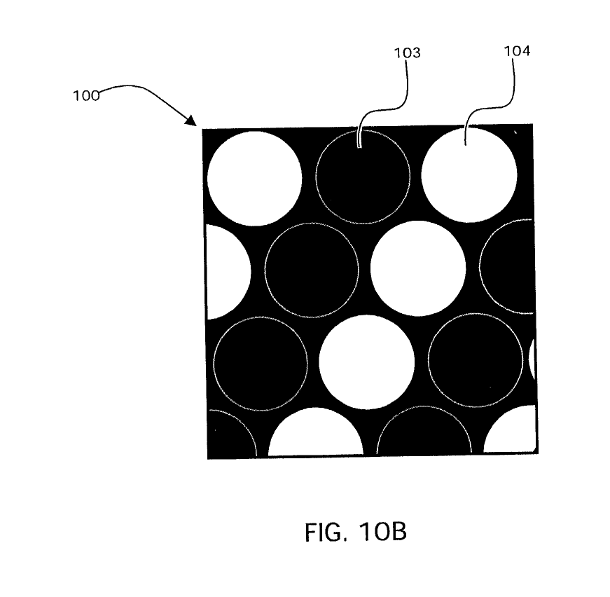

FIG. 9, shows another particular embodiment of a structure in accordance with the invention-for a two-color matrix display, 90 with longer wavelength, 91 and shorter-wavelength, 92 color elements. In this embodiment the matrix 100 can alternate between having, as shown in FIG. 10A, the longer wavelength elements, 101 turned on and emitting light while the shorter-wavelength elements, 102 are turned off, and then as shown in FIG. 10B, having the longer-wavelength elements, 103 turned off while the shorter-wavelength elements, 104 are turned on and emitting light. The eye/brain combination of the viewer will generally start to interpret the varying brightness levels of the doublets as a range of colors when the rate at which the two different-color emitters alternate begins to become faster than twelve times per second.

In a further optional embodiment, the systems and methods described herein include systems that introduce a noise signal into the two-color display image signal. For example, in one embodiment the systems and methods described herein include a software video device driver capable of driving a two-color display to create the perception of a full color display. In this embodiment, the method creates the perception of a full color display from matrix of optical elements of a first and second color. The first and second color selected for the two-color display may vary according to the application, but in the example below the two-color display comprises a red-green display including red optical elements and green optical elements that are arranged in an alternating display. Such displays are known in the art and commercially available, and any suitable two-color display may be employed with the systems and methods described herein without departing from the scope thereof. Such two-color displays may include LED displays, LCD) displays, polymer displays, CRTs, electronic paper displays, or any other type of display having two color elements that may be controlled for displaying a color image. further comprising a yellow border arranged around the periphery of the display.

Optionally, the display may also comprise a border formed as an edge around the two-color display, and having a color that comprises the colors of the first and second colors employed in the two color display. For example, a color display having red-green elements may have a yellow border. The yellow border may be formed as part of the image being displayed or may be a border that is placed around the edge of the display. Typically, the display is to be brighter or as bright as the image being displayed. The yellow border may be of spectral, or very narrow band, yellow or yellow formed from red-green components. Other colors may be spectral, narrow band, or typical combinations of other colors.

Continuing with the example embodiment of a device driver according to the invention, the system may include a computer process for processing an image file such as a JPEG image file, a GIF image file, a PNG image file, or any of the suitable file format for carrying image information. The process may analyze the color information within the image file to generate a two-color version of the image that determines for the image that is to be presented on a full color display, the relative brightness for the points of the image that are produced by the full color display. The process may translate the relative brightness of these points into a corresponding brightness for the respective points on a two-color display. The translation process employed may include the above described translation process wherein points within a three dimensional color space are mapped to points within a two dimensional color space. Additionally, the device driver may include a process for introducing noise into the image signal that is to be displayed on the two-color display. To this end, the filter may include a process that varies the long wave pass filter and short wave pass filter components periodically. Although not to be held by theory, such variation in the filter components is understood to increase the perception within a user of a two-color image appearing as a fill, true color image.

One example of this technique is depicted by table 1. Specifically, table 1 illustrates a table for three color components listed as blue (B), green (G), and red (R). As shown in table 1 for each color the B, G, R, a driver value is given. The driver value may represent a number between 0 and 255 that is employed by the system for understanding the relative brightness for that color component within a picture element (pixel) of the image. Thus, table 1 depicts driver values for B, G and R to be 120, 30 and 240 respectfully. As further shown in table 1, the driver values which are somewhat representative of the relative brightness of the component colors, may be multiplied by the filter factors to determine a brightness level that would be detected for this pixel element if the light had been passed through a long wave pass filter. In the example of table 1, the filter components include 5 percent, 40 percent and 100 percent. As shown in table 1 the long wave pass filter components for the elements B, G and R translate to brightness values of 6, 12 and 240 respectively. These values sum to 258.

A similar process may be employed for the filter components of a short wave pass filter. Specifically, table 1 represents the filter components of a short wave pass filter to be 100 percent, 40 percent and 5 percent for the B, G and R elements, respectively. After application of the filter, the relative brightness for the B, G and R elements are 120, 12 and 6. These values sum to 138. The summed values for the long wave pass filter, 258, and the short wave pass filter, 138, may be normalized to some number between 0 and 255 to create a pair of values for driving the long wave optical element and short wave optical element of a two-color display.

To better define colors within a three coordinate system with a two coordinate display, the video driver may vary the components of the long wave pass filter and the short wave pass filter. For example, the video driver process can vary the long wave pass filter components from 5 percent, 40 percent and 100 percent to 7 percent, 38 percent and 98 percent respectfully. This is an example of the type of deviation that can be made periodically to the image being displayed. The rate at which the filter components are changed in the image updated can vary according to the application, but in one practice the images varied at a rate of about 90 frames per second with the filter components changing each time a new frame is presented.

Optionally, in certain embodiments, the system introduces noise into the components of the two color display. To this end, the system may include a noise generator, such as a random number generator that generates a stream of random numbers within a selected range. The generated numbers may be added to the values of the display brightness for each, or one, of the two color display elements. The image may then be generated from the image signal that includes the noise.

TABLE I

| Color | Driver Value | LP Filter | LP Pixel | SP Filter | SP Pixel |
|---|---|---|---|---|---|
| B | 120 | ×.05 | 6 | ×1.00 | 120 |
| G | 30 | ×.40 | 12 | ×.40 | 12 |
| R | 240 | ×1.00 | 240 | ×.05 | 6 |
| | | | sum = 258 | | sum = 138 |

Those skilled in the art will know or be able to ascertain using no more than routine experimentation, many equivalents to the embodiments and practices described herein. For example, the systems and methods described herein may include client/server systems wherein the server system generates information for a two-color display and delivers that information to the two-color display for presenting an image that may be perceived as having a fill range of colors. Such embodiments may be employed with cell phones and other wireless devices that may have two color displays and that may receive image information from a remote server device that has such information or that is running a service that can generate such information from a full color image. It will also be understood that the systems described herein provide advantages over the prior art including the ability to reduce the cost of manufacturing devices that employ color images to present information to a user.

Accordingly, it will be understood that the invention is not to be limited to the embodiments disclosed herein, but is to be understood from the following claims, which are to be interpreted as broadly as allowed under the law.

We claim:

1. A method that gives the perception of a display with a full range of color from a matrix of optical elements of a first or a second color, comprising
providing a two-color display of optical elements of a first color and a second color and being arranged in an alternating pattern,
determining, for an image presented on a full color display, the relative brightness for points of the image produced by the full color display, and
translating the relative brightness of the points created by the full color display into a corresponding brightness for the respective points on the two-color display.

2. A method according to claim 1, wherein the step of translating includes mapping a three dimensional coordinate representative of the relative brightness of a point to a two dimensional point.

3. A method according to claim 1, including generating a flashing period representative of a timing pattern for flashing the two-color display.

4. A method according to claim 1, wherein flashing the two-color display includes alternating the display at the flashing period between the image presented in the first and the second color.

5. A method according to claim 4, including varying the flashing period.

6. A method according to claim 1, wherein the step of translating includes translating the relative brightnesses of a point in a red-green-blue image to a relative brightnesses of a two-dimensional point of the first and the second color.

7. A method according to claim 1, wherein the full color display includes red, green and blue emitters, and wherein the step of translating includes
summing the brightness for a three color red element with half the brightness of the three color green emitter to determine the relative brightness for the two-color first color emitter, and
summing the brightness for a three color blue elements with half the brightness of the three color green emitter to determine the relative brightness for the two-color second color emitter.

8. A method according to claim 7, including generating a noise signal, and
summing the noise signal with the relative brightness for the two-color of the first and/or the second color emitter.

9. A method according to claim 1, including the further step of providing a video driver for driving a video display as a function of the translated relative brightness of points for a two-color display.

10. A method according to claim 1, wherein the optical elements comprise light emitting diodes.

11. A method according to claim 1, wherein the optical elements comprise filters.

12. A method for creating the perception of a display with a full range of colors from a matrix of optical elements of a first or a second color, comprising
providing a two-color display of optical elements of a first and a second color arranged in an alternating pattern,
determining for an image presented on a three color display, the relative brightness for each point of the image produced by the three color display,
translating the relative brightness of each point created by the three color display into a corresponding brightness for the respective points on the two-color display, and sequentially activating optical elements of the first and the second color, for simulating the effect of a full color display.

13. An apparatus for visually displaying information on a two-color display, comprising
a display having two-color elements,
a memory device for storing information representative of a plurality of points for making up the image, each point being associated with information representative of three color components, and
a process for translating the relative brightness of the three color components to relative brightness levels for the two-color elements of the display.

14. An apparatus according to claim 13, further comprising a server system for executing the translation process and for delivering to the display having two color elements information representative of an image.

15. An apparatus according to claim 13, further including
a timer for periodically flashing the display.

16. An apparatus according to claim 13, further including
a noise generator for generating a noise signal having two-color components and for delivering the noise signal to the video driver process for processing the noise signal with the three color components of the image.

17. An apparatus according to claim 16 including a dynamically changing filter for introducing variation into the translation of the relative brightness of the three color components to relative brightness for the two-color elements.

18. An apparatus according to claim 13, wherein the process includes
a process for summing the brightness for a first one of the three color components with half the brightness of a second one of the three color components to determine the relative brightness for a first color component of the display, and
summing the brightness for a third color component with half the brightness of the second color component to determine the relative brightness for the second color component of the display.

19. An apparatus according to claim 13, wherein the process includes
a process for determining the long wavelength component of a two color display by multiplying the numbers representative of relative brightness of three colors in a three color display by values representative of the effect of a longwave pass filter, and summing the generated numbers to provide the relative brightness of that point in the long wave component of the two color display, and
a process for determining the short wavelength component of a two color display by multiplying the number s representative of relative brightness of three colors in a three color display by values representative of the effect of a shortwave pass filter, and summing the generated numbers to provide the relative brightness of that point in the short wave component of the two color display.

20. An apparatus according to claim 13, further comprising a border having a color that is the combination of the first and the second colors or the two color display and being arranged substantially around the periphery of the display.

21. An apparatus to claim 20, wherein the border comprises part of the image displayed to the user.

22. An apparatus according to claim 20, wherein the border comprises colored border formed as an edge around the two-color display.

23. An apparatus according to claim 20, wherein the border comprises a yellow border of spectral yellow or yellow formed from red-green components.

24. An apparatus according to claim 13, wherein the two-color display include a display selected from the group consisting of an LED display, and LCD display, a light emitting polymer display and a CRT display.
